(19) United States
(12) Patent Application Publication
(10) Pub. No.: US 2014/0329152 A1
(43) Pub. Date: Nov. 6, 2014

(54) SECONDARY BATTERY

(71) Applicant: KAWASAKI JUKOGYO KABUSHIKI KAISHA, Kobe-shi, Hyogo (JP)

(72) Inventors: Daisuke Kouzaki, Kakogawa-shi (JP); Makoto Ryoji, Kobe-shi (JP)

(21) Appl. No.: 14/357,330

(22) PCT Filed: Dec. 14, 2012
(86) PCT No.: PCT/JP2012/008022

§ 371 Date: May 9, 2014

(30) Foreign Application Priority Data
Dec. 21, 2011 (JP) 2011-279608

(51) Int. Cl. H01M 2/26

(52) U.S. Cl. CPC H01M 2/263
USPC 429/233

(57) ABSTRACT

A secondary battery according to the present invention includes: a positive electrode current collector and a negative electrode current collector, arranged to face each other; a plurality of positive and negative electrodes arranged between the positive electrode current collector and the negative electrode current collector and stacked in a direction perpendicular to a facing direction of the current collectors, such that the positive and negative electrodes face each other with a separator in between; and an electrically conductive plate disposed parallel to the plurality of positive and negative electrodes. At least the positive or negative electrodes are formed in such a manner as to sandwich the plate from both sides. The plate protrudes, in the facing direction of the current collectors, from at least one end of the electrode that sandwiches the plate.

### TECHNICAL FIELD

The present invention relates to a secondary battery, and particularly to a secondary battery with features in its electrode stacked structure.

### BACKGROUND ART

Conventionally, secondary batteries have been used in various products such as mobile phones, mobile PCs, electric tools, and power-assisted bicycles. In recent years, it is well known that secondary batteries are mounted in vehicles such as hybrid automobiles, electric automobiles, and electric railcars. Moreover, secondary batteries are utilized in battery power systems, utilized in power generation based on natural energy such as wind power generation and solar power generation, and utilized in stabilization of power systems. In such usage, secondary batteries are used for compensating for an unstable output or smoothing an output. Large-capacity and large-sized secondary batteries are used in such usage.

There are various secondary batteries such as spiral-wound batteries and rectangular batteries. In a case where large-capacity and large-sized secondary batteries are required, rectangular batteries are often used from the standpoint of installation space and productivity of the batteries. The structure of a rectangular battery is, for example, as follows: an electrode unit is formed by alternately stacking a plurality of positive and negative electrodes with a separator in between; and the electrode unit is accommodated in a battery container together with an electrolyte solution. The plurality of positive and negative electrodes are in contact with positive and negative current collectors, respectively, and thereby electrical conduction is secured.

Here, if the electrodes and the current collectors are displaced relative to each other, and thereby the contact between the electrodes and the current collectors becomes insufficient, then there is a risk of degradation in battery capacity and that in battery performance, for example, by increasing contact resistance. In order to prevent such a problem, it is necessary to maintain a state where the electrodes and the current collectors are firmly and securely in contact with each other.

In this respect, there is a disclosed invention in which end faces of respective stacked electrodes are directly welded to a current collector by electronic beam welding (see Patent Literature 1, for example). That is, the disclosed invention is a method of bringing each electrode into contact with a surface of the current collector at the right angle and joining each electrode in such a state to the surface. Here, the current collector and each electrode form a T-joint (see FIG. 1(d) and FIG. 2(b) of Patent Literature 1).

The applicant of the present application has proposed a secondary battery with a structure described below (see Patent Literature 2, for example). The secondary battery disclosed in Patent Literature 2 includes: a plate-shaped positive electrode current collector 23 and a plate-shaped negative electrode current collector 25, which are arranged to face each other; an electrode unit 17 including a plurality of positive electrodes 13 and negative electrodes 15, both of which are arranged between the current collectors and alternately stacked in a direction perpendicular to a facing direction X of the current collectors, such that the positive and negative electrodes face each other with a separator 11 in between; and a sheet-shaped buffer member 31 interposed between one of the current collectors and the electrode unit 17 and between the other current collector and the electrode unit 17, the sheet-shaped buffer member 31 including a conductive material (see FIG. 3 of Patent Literature 2).

### CITATION LIST

### Patent Literature

PTL 1: Japanese Patent No. 2616197

PTL 2: Japanese Laid-Open Patent Application Publication No. 2011-150913

### SUMMARY OF INVENTION

### Technical Problem

However, in the invention of Patent Literature 1, there is a welded portion at the contact point between each electrode and the current collector, and welding swarf may cause problems such as internal short-circuit. Moreover, for example, adjustment of the position where each electrode and the current collector are welded together is complicated, which results in poor productivity.

Interposing a sheet-shaped buffer member between an electrode and a current collector to maintain electrical conduction between the electrode and the current collector as in the invention of Patent Literature 2 is useful. However, the present invention takes a different approach to secure the electrical conduction between the electrode and the current collector, aiming to maintain the electrical conduction for a longer term.

In a secondary battery, an electrode expands and contracts due to charging and discharging. The reason for this is that an active material contained in the electrode expands and contracts. The expansion and contraction of the electrode cause changes in contact pressure. Moreover, long-term use of the secondary battery causes, for example, creep of the separator and bending of the electrode, resulting in insufficient contact pressure between the electrode and the current collector. Consequently, there is a risk of degradation in battery performance.

An object of the present invention is to suppress changes in contact pressure between an electrode and a current collector due to expansion and contraction of the electrode, thereby maintaining electrical conduction between the electrode and the current collector and suppressing degradation in battery performance. Thus, a long-lived secondary battery with excellent reliability is provided.

### Solution to Problem

In order to achieve the above object, a secondary battery according to the present invention includes: a positive electrode current collector and a negative electrode current collector, arranged to face each other; a plurality of positive and negative electrodes arranged between the positive electrode current collector and the negative electrode current collector and stacked in a direction perpendicular to a facing direction of the current collectors, such that the positive and negative electrodes face each other with a separator in between; and an electrically conductive plate disposed parallel to the plurality of positive and negative electrodes. At least the positive or negative electrodes are formed in such a manner as to sandwich the plate from both sides. The plate protrudes, in the facing direction of the current collectors, from at least one end of the electrode that sandwiches the plate.

According to the above structure, electrodes that tend to readily expand and contract are formed in such a manner as to sandwich the electrically conductive plate from both sides. Accordingly, even if the electrode expands and contracts, it is less likely that such changes in the electrode directly affect a current collector and the separator. This makes it possible to suppress changes in contact pressure between the electrode and the current collector and between the electrode and the separator. Therefore, electrical conduction between the electrode and the current collector can be maintained, and degradation in battery performance can be suppressed, which makes it possible to provide a long-lived secondary battery with excellent reliability.

In the description herein, the term “one end” of the electrode refers to an end at the corresponding current collector side or an end at the separator side. In a case where the plate protrudes from the end of the electrode at the corresponding current collector side, the plate absorbs the electrode's expansion and contraction occurring at the corresponding current collector side, and thereby the contact between the current collector and the plate is stably maintained and the electrical conduction is secured. Meanwhile, in a case where the plate protrudes from the end of the electrode at the separator side, the plate absorbs the electrode's expansion and contraction occurring at the separator side, and thereby creep of the separator due to the electrode's expansion and contraction is suppressed. The dimensions of the protrusion of the plate may be such dimensions as to be able to absorb the expansion and contraction of the electrode. When the dimensions of the protrusion are increased, the electrode becomes relatively short, which is unfavorable from the standpoint of battery energy density. The dimensions of the protrusion of the plate are preferably 1 to 5% of the dimensions of the electrode although they depend on the electrode to be used. It should be noted that the plate is preferably formed of an electrically conductive alkali-resistant material. The plate may be, for example, a nickel-plated steel plate, a nickel plate, a titanium-plated steel plate, a titanium plate, or a stainless steel plate.

Moreover, the wording “at least the positive or negative electrodes” means that the above-described electrode structure may be applied to either the positive electrodes or the negative electrodes, or to both the positive and negative electrodes. For example, in the case of a nickel-metal hydride secondary battery in which a nickel foam is used as a substrate of the positive electrode and a steel plate is used as a substrate of the negative electrode, it is effective to apply the above-described electrode structure to the positive electrodes which have a relatively large expansion and contraction rate. Furthermore, the wording “formed in such a manner as to sandwich the plate from both sides” means, for example, sandwiching the electrically conductive plate from both sides by a pair of plate-shaped electrodes, or folding an electrode to cover, at least partially, both surfaces of the electrically conductive plate in such a manner as to sandwich the electrically conductive plate.

In the above secondary battery, the plate and the electrode that sandwiches the plate may be not fixed to each other. The wording “not fixed to each other” means a structure where the plate and the electrode that sandwiches the plate are not integrated together by bonding, coating, welding, or the like. For example, the structure may be realized by pressing the plate from both sides via the electrode for holding. According to this structure, the electrode is not fixed to the plate. Therefore, expansion and contraction of the electrode do not affect the plate, which makes it possible to suppress changes in contact pressure. Even if the electrode is in contact with either the current collector or the separator, when the electrode expands, the electrode slides toward a non-contacting side (plate-protruding side). Accordingly, influence of the expansion and contraction of the electrode on the separator and the current collector can be suppressed. In addition, a process of for example, bonding, coating, or welding between the electrode and the plate can be eliminated. It should be noted that although the plate and the electrode that sandwiches the plate may be partially fixed to each other, it is unfavorable if the entire surfaces between the plate and the electrode that sandwiches the plate are fixed to each other. If the entire surfaces between the plate and the electrode that sandwiches the plate are fixed to each other, then there arises a case where changes in contact pressure due to the expansion and contraction of the electrode cannot be suppressed.

The electrode that sandwiches the plate may be formed as a pair of plate-shaped electrodes containing an active material. The pair of electrodes may be formed in such a manner as to sandwich the plate. In this manner, the structure can be simplified, in which the plate is simply disposed between the pair of electrodes. As a result, increase in manufacturing costs can be suppressed. It should be noted that the thickness of each of the pair of electrodes may be set to substantially ½ of the thickness of an ordinary electrode (that does not sandwich the plate). This makes it possible to realize substantially the same battery design as the design of a battery having a structure in which ordinary electrodes are stacked.

The plate may protrude, in the facing direction of the current collectors, from both ends of the electrode that sandwiches the plate. According to this structure, the plate can absorb expansion and contraction of the electrode at both ends of the electrode. Moreover, since the plate exists like a pillar between the current collector and the separator, the structure of the battery is stabilized.

The at least the positive or negative electrodes may be electrodes that contain an active material and that are folded to sandwich the plate. According to this structure, the plate protrudes from an end of the electrode, the end being at the opposite side to a folded portion of the electrode. The plate absorbs expansion and contraction of the electrode at the aforementioned end of the electrode. It should be noted that the protruding portion of the plate may be positioned at either the current collector side or the separator side.

A folded portion of the electrode may contain no active material. According to this structure, since the folded portion contains no active material, the electrode can be easily folded and readily produced. If the folded portion of the electrode is disposed at the current collector side, then the folded portion can be utilized as a buffer member. A structure in which the folded portion of the electrode contains no active material can be realized, for example, in a manner described below. At the time of forming the folded portion of the electrode, a folding groove may be formed in a porous nickel substrate by pressing. Thus, pores in the substrate are crushed and thereby no active material enters the pores. It should be noted that the electrode and the plate may be not fixed to each other; that the folded portion of the electrode and the plate may be welded together; or that the vicinity of the folded portion of the electrode and the plate may be welded together.

The plate may be a nickel-plated steel plate. According to this structure, since a nickel-plated steel plate is used as the plate, the plate is electrically conductive and alkali-resistant, and even if the plate is formed to be thin, the plate maintains certain strength. The plate is required to have such strength as to be able to bear pressure that is applied in the facing direction of the current collectors, while it is preferred that the plate be thin in order to obtain high energy density of the battery.

An electrode stacked structure of a secondary battery according to the present invention includes: a positive electrode current collector and a negative electrode current collector, arranged to face each other; and a plurality of positive and negative electrodes arranged between the positive electrode current collector and the negative electrode current collector and stacked in a direction perpendicular to a facing direction of the current collectors, such that the positive and negative electrodes face each other with a separator in between. At least the positive or negative electrodes are formed in such a manner as to sandwich an electrically conductive plate from both sides. The plate protrudes, in the facing direction of the current collectors, from at least one end of the electrode that sandwiches the plate. The plate and the electrode that sandwiches the plate are not fixed to each other.

The above-described object, other objects, features, and advantages of the present invention will be made clear by the following detailed description of a preferred embodiment with reference to the accompanying drawings.

### Advantageous Effects of Invention

As described above, the secondary battery according to the present invention makes it possible to suppress changes in contact pressure between an electrode and a current collector and maintain electrical conduction between the electrode and the current collector, thereby suppressing degradation in battery performance. As a result, the battery can be made long-lived, and the reliability of the battery can be improved.

### BRIEF DESCRIPTION OF DRAWINGS

FIG. 1 is a partially cutaway side view showing a battery module, in which a secondary battery according to one embodiment of the present invention is used.

FIG. 2 is a partially cutaway perspective view of the secondary battery according to the embodiment of the present invention.

FIG. 3A is a partially cutaway plan view of FIG. 2.

FIG. 3B is an enlarged view of part of FIG. 3A.

FIG. 3C shows buffer members interposed between an electrode unit and current collectors.

FIG. 4 is a perspective view showing a structure of a positive electrode used in the secondary battery shown in FIG. 2.

FIG. 5A is a front view of the positive electrode shown in FIG. 4.

FIG. 5B is a front view showing a variation of the positive electrode.

FIG. 5C is a front view showing a variation of the positive electrode.

FIG. 5D is a front view showing a variation of the positive electrode.

FIG. 5E is a front view showing a variation of the positive electrode.

FIG. 5F is a front view showing a variation of the positive electrode.

FIG. 6 is a flowchart showing steps of producing the positive electrodes shown in FIGS. 5C to 5F.

FIG. 7 illustrates a positive electrode holding structure of the secondary battery according to the embodiment of the present invention.

FIG. 8A illustrates a normal state of a positive electrode in a conventional secondary battery.

FIG. 8B illustrates an expanded state of the positive electrode in the conventional secondary battery.

FIG. 8C illustrates a contracted state of the positive electrode in the conventional secondary battery.

### DESCRIPTION OF EMBODIMENTS

Hereinafter, one embodiment according to the present invention is described with reference to the drawings. However, the present invention is not limited to the embodiment described below.

(Structure of Battery Module)

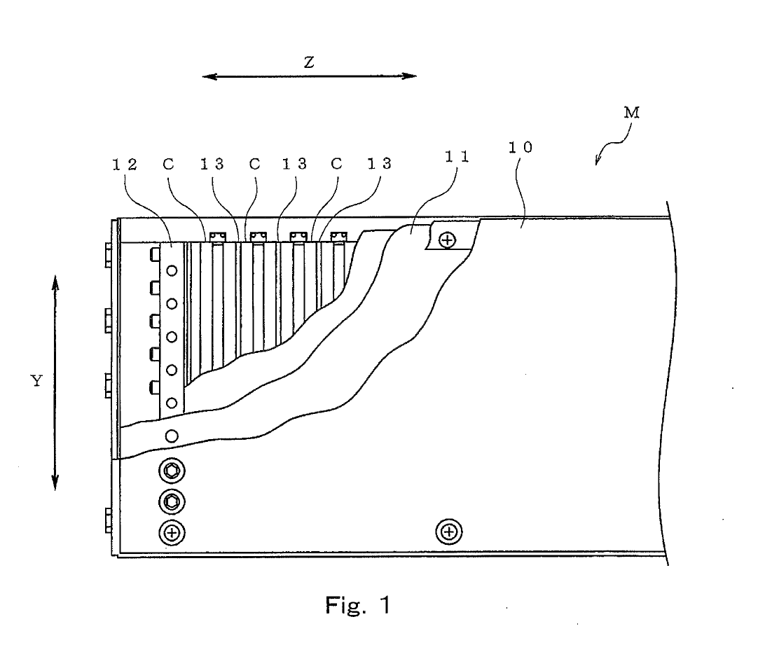

As shown in FIG. 1, in a battery module M, a plurality of (in the present embodiment, 30) secondary batteries C, which are nickel-metal hydride secondary batteries, are stacked in their thickness direction (Z-direction). The battery module M includes a side board 11 and a compression board 12 surrounding the secondary batteries C. The side board 11, the compression board 12, and the secondary batteries C are covered by a casing 10 which is formed of an insulating material. The side board 11, the compression board 12, and the casing 10 are fastened together by bolts or screws, such that the 30 secondary batteries C are held in a state of being pressed against one another in the stacking direction (Z-direction). It should be noted that each secondary battery C is configured such that a surface of a positive electrode current collector 7, the surface being exposed to the outside of the battery, functions as a positive electrode terminal surface; and that a surface of a negative electrode current collector 8, the surface being exposed to the outside of the battery, functions as a negative electrode terminal surface. The positive electrode terminal surface of one secondary battery C and the negative electrode terminal surface of the adjacent secondary battery C are electrically connected to each other via an electrically conductive heat sink 13.

(Structure of Secondary Battery)

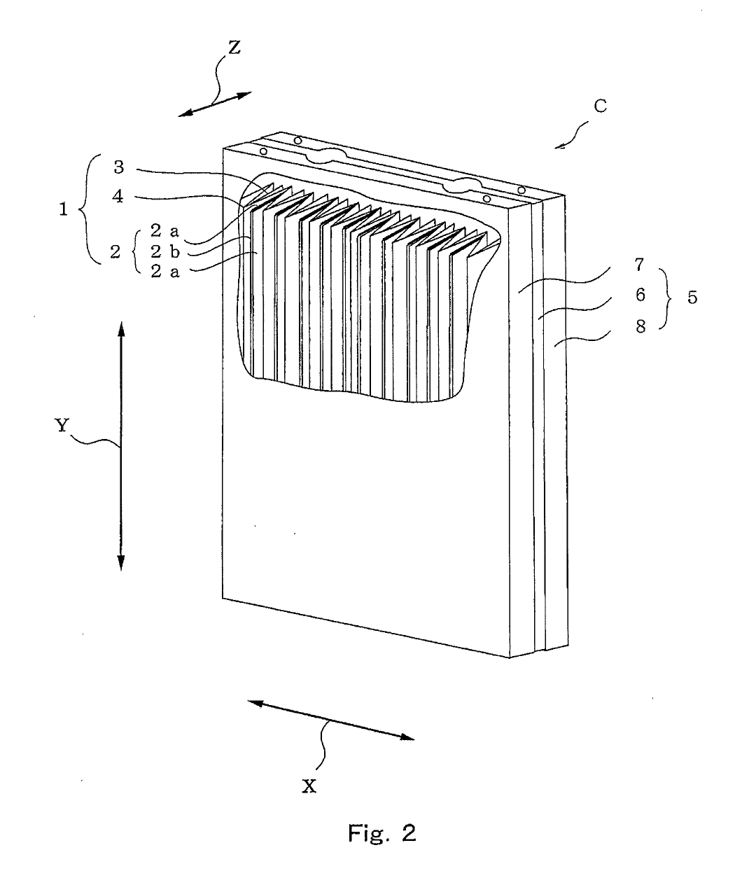

As shown in FIG. 2, in each secondary battery C, an insulating rectangular framework member 6, the plate-shaped positive electrode current collector 7, and the plate-shaped negative electrode current collector 8 form a rectangular cell 5. The plate-shaped positive electrode current collector 7 and the plate-shaped negative electrode current collector 8 are arranged to face each other in the Z-direction in such a manner as to cover the framework member 6. The cell 5 accommodates therein an electrode unit 1 together with an electrolyte solution. The electrode unit 1 includes: positive electrode groups 2, each including a pair of plate-shaped (strip-shaped) positive electrodes 2a, two of the plate-shaped positive electrodes forming the pair, and a strip-shaped plate 2b formed of a nickel-plated steel plate; strip-shaped negative electrodes 3, each containing a negative electrode active material; and a separator 4 folded in a pleat-like form. It should be noted that the positive electrode structure including the positive electrodes 2a and the plate 2b will hereinafter be called a positive electrode group in order to clearly distinguish the positive electrode structure from an ordinary positive electrode.

It should be noted that, in the present embodiment, a substrate formed of a porous nickel foam or nickel sintered body is used as the positive electrode 2a. The positive electrode 2a is impregnated with a positive electrode active material that contains nickel hydroxide as a major component. A substrate formed of a perforated metal, the perforated metal being obtained by forming a large number of pores on a nickel-plated steel plate, is used as the negative electrode 3. The negative electrode 3 is impregnated with a negative electrode active material that contains a hydrogen storage alloy as a major component. A hydrophilic separator formed of a polypropylene-based nonwoven fabric is used as the separator 4. An alkaline aqueous solution is used as the electrolyte solution. A nickel-plated steel plate is used as the positive electrode current collector 7 and the negative electrode current collector 8.

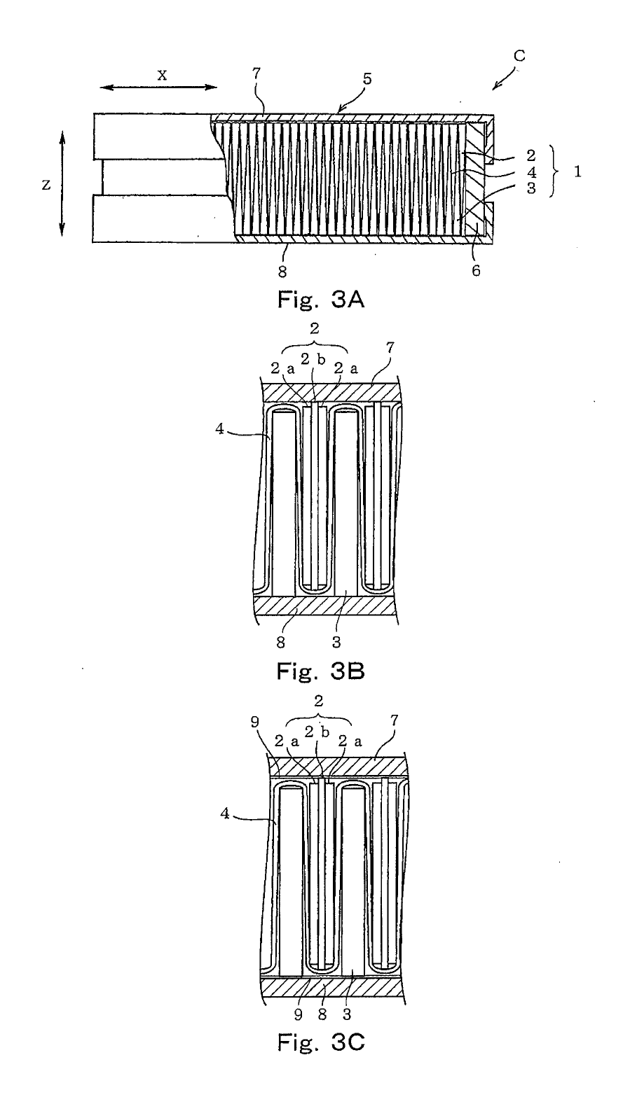

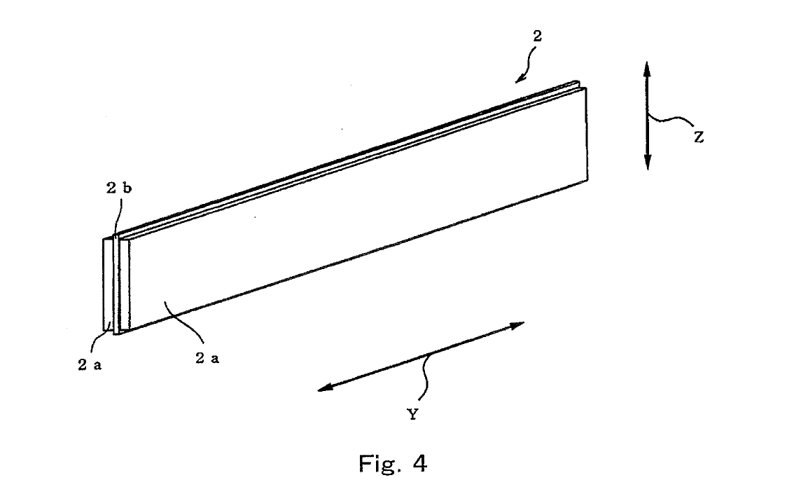

As shown in FIG. 3A and FIG. 3B, the electrode unit 1 has a stacked structure, in which the positive electrode groups 2 and the negative electrodes 3 are alternately stacked in an X-direction with the separator 4 in between. The separator 4 is folded in a pleat-like form. The X-direction is perpendicular to the direction (Z-direction) in which the current collectors 7 and 8 face each other. The positive electrode group 2 is formed such that the pair of positive electrodes 2a sandwiches the plate 2b from both sides. The plate 2b is formed such that the plate 2b protrudes from both ends of the positive electrodes 2a in their width direction (Z-direction). It should be noted that the positive electrodes 2a and the plate 2b are not fixed to each other, but are in contact with each other owing to pressing force applied from both sides, allowing the positive electrodes 2a and the plate 2b to be electrically conductive with each other. One end of the plate 2b (the end at the positive electrode current collector 7 side) is in contact with the positive electrode current collector 7, allowing the positive electrode group 2 to be electrically conductive with the positive electrode current collector 7. One end of the negative electrode 3 (the end at the negative electrode current collector 8 side) is in contact with the negative electrode current collector 8, allowing the negative electrode 3 to be electrically conductive with the negative electrode current collector 8. In the secondary battery C, the electrical conduction between the positive electrode group 2 and the positive electrode current collector 7, and the electrical conduction between the negative electrode 3 and the negative electrode current collector 8, are secured not by welding but by pressing owing to the tensile strength of the separator 4 in order to prevent contamination by foreign matter such as metal swarf and to simplify the process.

It should be noted that, as shown in FIG. 3C, an electrically conductive sheet-shaped buffer member may be interposed between the electrode unit 1 and the positive electrode current collector 7 and between the electrode unit 1 and the negative electrode current collector 8. By interposing the buffer member, the positive electrode group 2 and the positive electrode current collector 7 can be securely brought into contact with each other, and the negative electrode 3 and the negative electrode current collector 8 can be securely brought into contact with each other. This makes it possible to further improve the electrical conduction among these components. With the use of the buffer member, variation in contact pressure, due to factors such as variation in the dimensions of the positive electrode groups 2 and the negative electrodes 3, can be suppressed, which makes it possible to further improve the battery performance.

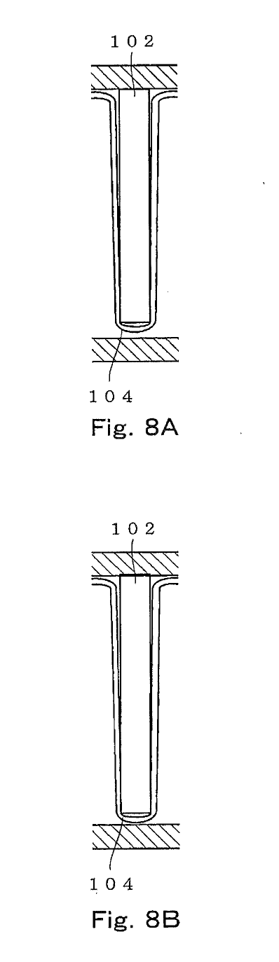

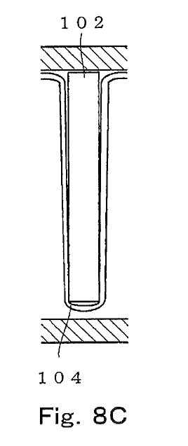

As previously described, when a secondary battery is charged and discharged, positive and negative electrodes repeat expansion and contraction. As shown in FIGS. 8A to 8C, in a conventional secondary battery, the separator is stretched when the positive and negative electrodes expand and contract. In a long term, there is a risk that creep occurs in the separator. If creep occurs in the separator, the tensile strength of the separator is reduced. As a result, the contact pressure between the positive electrode and the positive electrode current collector, and the contact pressure between the negative electrode and the negative electrode current collector, are reduced. In this case, there is a possibility that sufficient battery performance cannot be obtained thereby.

Meanwhile, if such a structure as in the secondary battery C according to the present embodiment, in which the plate 2b protrudes from the positive electrodes 2a in the positive electrode group 2, is adopted, then the protrusion of the plate 2b can absorb the expansion and contraction of the positive electrodes 2a due to the charging and discharging. This makes it possible to suppress influence of the expansion and contraction of the positive electrodes 2a on the separator 4 and the positive electrode current collector 7, thereby suppressing degradation in battery performance. As a result, the battery can be made long-lived.

The positive electrodes 2a and the plate 2b are not fixed to each other, and the electrical conduction between the positive electrodes 2a and the plate 2b is obtained only by the pressing force via the separator 4. This allows the positive electrodes 2a to smoothly expand and contract in the width direction of the positive electrodes 2a (Z-direction).

It should be noted that, in the present embodiment, a structure using a plate is applied only to the positive electrode 2a whose expansion and contraction rate is relatively high. However, this structure may be applied also to the negative electrode 3. Thus, the structure using a plate may be applied to both the positive electrode 2a and the negative electrode 3.

(Structure and Variations of Positive Electrode)

Hereinafter, the structure of the positive electrode group 2 of the secondary battery C according to the present embodiment and its variations are described. This structure is also applicable to the negative electrode 3 in a similar manner.

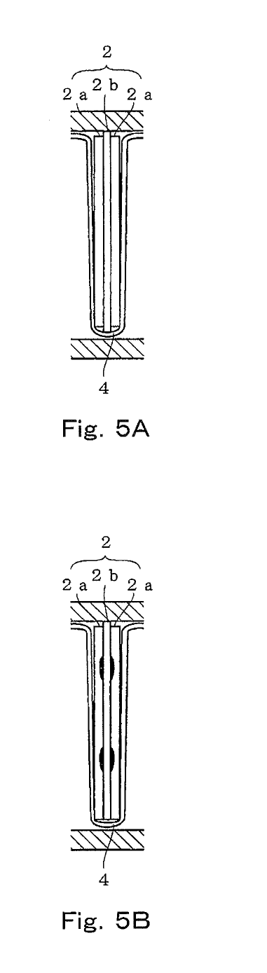

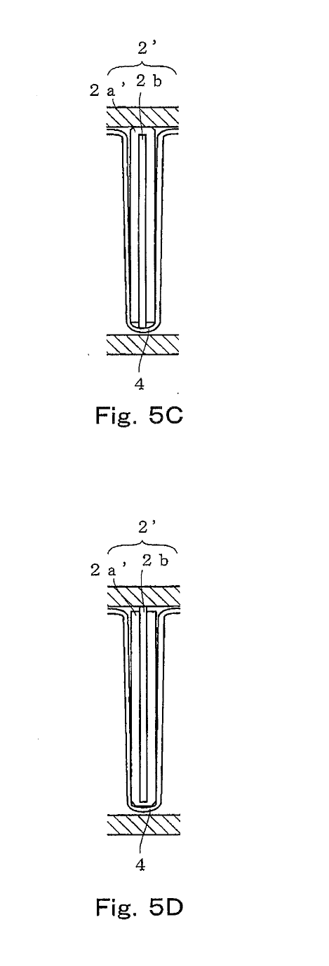

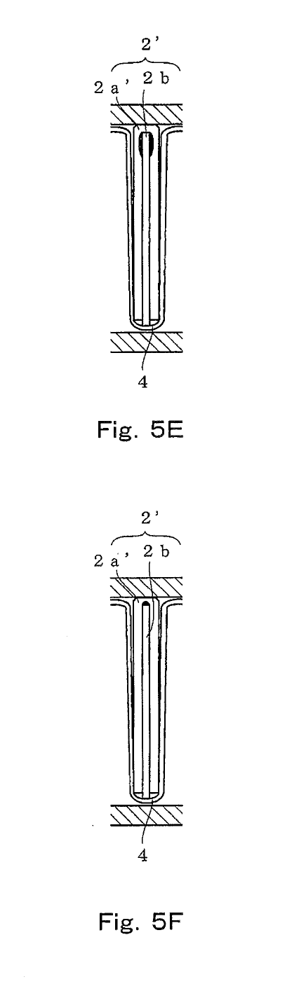

(1) As shown in FIG. 4 and FIG. 5A, the positive electrode group 2 of the secondary battery C is configured such that the pair of positive electrodes 2a sandwiches the plate 2b from both sides. Specifically, the structure of the positive electrode group 2 is such that both ends of the plate 2b protrude from the positive electrodes 2a; while the strip-shaped positive electrodes 2a are in contact with both sides of the strip-shaped plate 2b whose width is approximately 1 to 5% greater than that of each strip-shaped positive electrode 2a.

(2) Next, variations of the positive electrode group 2 are described below. In the description below, the same components as those previously described are denoted by the same reference signs as those used in the previous description. As shown in FIG. 5B, the positive electrode group 2 may have an alternative structure, in which one end of the plate 2b protrudes from the positive electrodes 2a. Moreover, the positive electrodes 2a and the plate 2b may be partially fixed to each other by welding or the like. It should be noted that, if the entire surfaces between the plate 2b and the positive electrodes 2a are fixed to each other, then expansion and contraction of the positive electrode active material affect the plate 2b, causing changes in contact pressure. Therefore, preferably, the positive electrodes 2a and the plate 2b are partially fixed to each other.

(3) As shown in FIG. 5C, an alternative structure may be adopted, in which a positive electrode 2a′ is longitudinally folded at the center in its width direction to sandwich the plate 2b. In this case, the folded portion of the positive electrode 2a′ is not impregnated with the positive electrode active material. Accordingly, the positive electrode 2a′ can be readily folded, and the folded portion can be utilized as a buffer member. It should be noted that, in this variation, the folded portion of the positive electrode 2a′ is positioned at the end of the positive electrode current collector 7 side of the positive electrode 2a′. Alternatively, the positive electrode group 2′ may be disposed in a reverse orientation as shown in FIG. 5D. That is, the folded portion of the positive electrode 2a′ may be positioned at the end of the negative electrode current collector 8 side of the positive electrode 2a′. Also, in the case where the positive electrode 2a′ is folded, the positive electrode 2a′ and the plate 2b may be not fixed to each other as shown in FIG. 5C and FIG. 5D. Alternatively, the positive electrode 2a′ and the plate 2b may be partially fixed to each other by welding or the like as shown in FIG. 5E and FIG. 5F. It should be noted that a state shown in FIG. 5E is such that, in the variation of FIG. 5C, the main surfaces of the plate 2b are fixed to the vicinity of the folded portion of the positive electrode 2a′ by welding or the like. Further, a state shown in FIG. 5F is such that, in the variation of FIG. 5C, an end (side face) of the plate 2b at the folded portion side of the positive electrode 2a′, and the positive electrode 2a′, are fixed to each other by welding or the like. The manners of fixing as shown in FIG. 5E and FIG. 5F are also applicable to the example shown in FIG. 5D.

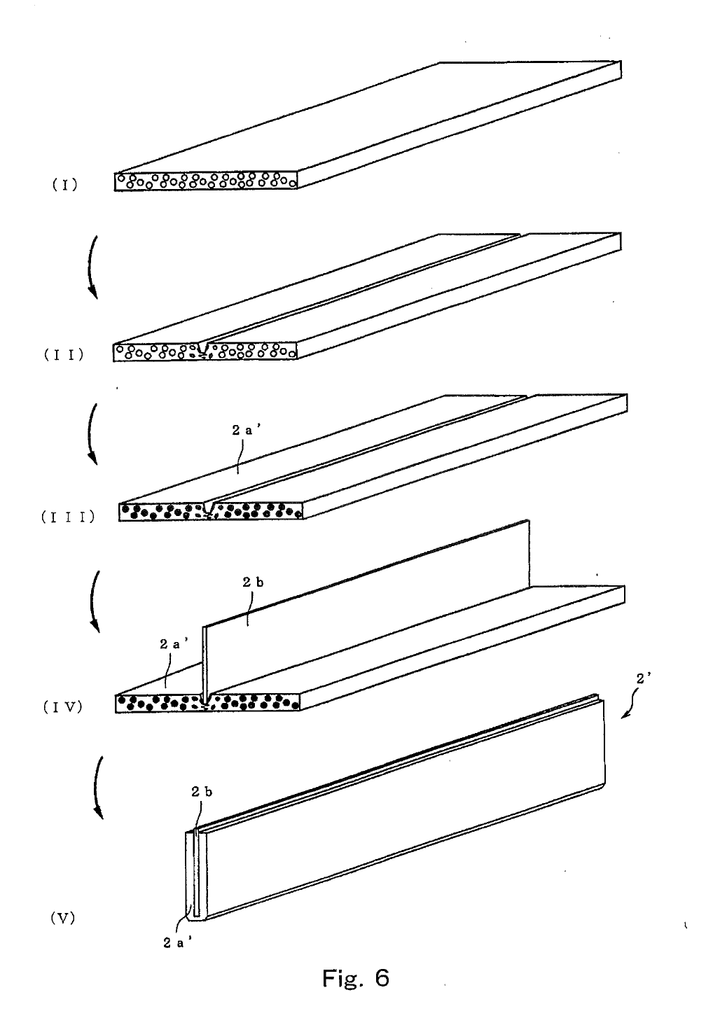

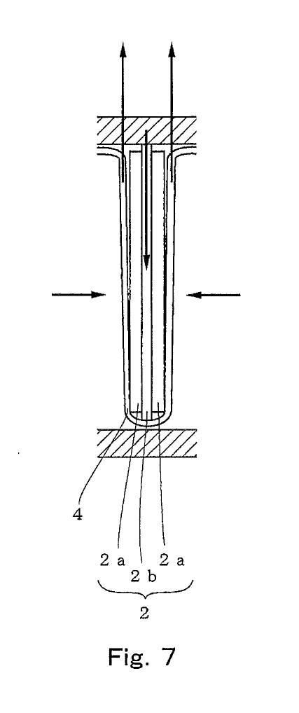

(4) It should be noted that the positive electrode groups 2 as shown in FIGS. 5C to 5F, each of which has a structure in which the positive electrode 2a′ is folded, may be produced in a manner described below. As shown in FIG. 6, first, at the center in the width direction of a substrate of the positive electrode 2a′ having pores formed therein (I), a folding groove (which is later formed into a folded portion) is formed in the longitudinal direction by pressing. By forming the folding groove by the pressing, the pores in the substrate of the positive electrode 2a′ are crushed at the folded portion (II). Thereafter, a positive electrode active material is applied onto the substrate of the positive electrode 2a′; or the substrate of the positive electrode 2a′ is impregnated with the positive electrode active material, to load the pores with the positive electrode active material. At the time, since the pores have already been crushed at the folded portion (folding-groove forming portion), the positive electrode active material does not enter the folded portion (III). Subsequently, an end portion of the plate 2b is set in the folding groove (IV), and then the positive electrode 2a′ is folded along the folding groove in such a manner as to sandwich the plate 2b, so that the positive electrode group 2′ is completed (V). It should be noted that an end portion of the plate 2b, the end portion being positioned at the opposite side to the folded portion of the positive electrode 2a′, is made to protrude from the positive electrode 2a′ when the positive electrode 2a′ is folded. It should be noted that, in a case where the positive electrode 2a′ and the plate 2b are partially fixed to each other in a manner as shown in FIG. 5E or FIG. 5F, the plate 2b and the positive electrode 2a′ are partially welded to each other by ultrasonic welding or the like.

Although the preferred embodiment of the present invention is described above with reference to the drawings, various additions, alterations, and deletions can be made to the above embodiment without departing from the spirit of the present invention. In particular, the electrode stacked structure according to the present invention is applicable not only to positive electrodes but also to negative electrodes.

From the foregoing description, numerous modifications and other embodiments of the present invention are obvious to one skilled in the art. Therefore, the foregoing description should be interpreted only as an example and is provided for the purpose of teaching the best mode for carrying out the present invention to one skilled in the art. The structural and/or functional details may be substantially altered without departing from the spirit of the present invention.

### REFERENCE SIGNS LIST

1 electrode unit
2 positive electrode group
2a positive electrode
2b plate
3 negative electrode
4 separator
5 rectangular cell
6 framework member
7 positive electrode current collector
8 negative electrode current collector
10 casing
11 side board
12 compression board
13 heat sink
C secondary battery
M battery module

1. A secondary battery comprising:
a positive electrode current collector and a negative electrode current collector, arranged to face each other;
a plurality of positive and negative electrodes arranged between the positive electrode current collector and the negative electrode current collector and stacked in a direction perpendicular to a facing direction of the current collectors, such that the positive and negative electrodes face each other with a separator in between; and
an electrically conductive plate disposed parallel to the plurality of positive and negative electrodes, wherein
at least the positive or negative electrodes are formed in such a manner as to sandwich the plate from both sides,
the plate protrudes, in the facing direction of the current collectors, from at least one end of the electrode that sandwiches the plate, and
the plurality of positive and negative electrodes are electrically conductive with the positive and negative electrode current collectors, respectively.

2. The secondary battery according to claim 1, wherein the plate and the electrode that sandwiches the plate are not fixed to each other.

3. The secondary battery according to claim 1, wherein
the electrode that sandwiches the plate is formed as a pair of plate-shaped electrodes containing an active material, and
the pair of electrodes is formed in such a manner as to sandwich the plate.

4. The secondary battery according to claim 1, wherein the plate protrudes, in the facing direction of the current collectors, from both ends of the electrode that sandwiches the plate.

5. The secondary battery according to claim 1, wherein the at least the positive or negative electrodes are electrodes that contain an active material and that are folded to sandwich the plate.

6. The secondary battery according to claim 5, wherein a folded portion of the electrode contains no active material.

7. The secondary battery according to claim 1, wherein the plate is a nickel-plated steel plate.

8. An electrode stacked structure of a secondary battery, the electrode stacked structure comprising:
a positive electrode current collector and a negative electrode current collector, arranged to face each other; and
a plurality of positive and negative electrodes arranged between the positive electrode current collector and the negative electrode current collector and stacked in a direction perpendicular to a facing direction of the current collectors, such that the positive and negative electrodes face each other with a separator in between, wherein
at least the positive or negative electrodes are formed in such a manner as to sandwich an electrically conductive plate from both sides,
the plate protrudes, in the facing direction of the current collectors, from at least one end of the electrode that sandwiches the plate,
the plate and the electrode that sandwiches the plate are not fixed to each other, and
the plurality of positive and negative electrodes are electrically conductive with the positive and negative electrode current collectors, respectively.
